(19) United States
(12) Patent Application Publication
(10) Pub. No.: US 2009/0204542 A1
(43) Pub. Date: Aug. 13, 2009

(54) PRIVATELY SHARING RELYING PARTY REPUTATION WITH INFORMATION CARD SELECTORS

(75) Inventors: Thomas E. Doman, Pleasant Grove, UT (US); Daniel S. Sanders, Orem, UT (US); Duane F. Buss, West Mountain, UT (US); Andrew A. Hodgkinson, Pleasant Grove, UT (US); James G. Sermersheim, Woodland Hills, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 12/042,205

(22) Filed: Mar. 4, 2008

Related U.S. Application Data
(63) Continuation-in-part of application No. 12/030,063, filed on Feb. 12, 2008.
Application No. 12/030,063 is a continuation-in-part of application No. 12/029,373, filed on Feb. 11, 2008.

(51) Int. Cl. G06Q 20/00; H04L 9/32

(52) U.S. Cl. 705/50; 705/35

(57) ABSTRACT

A computer system accesses reputation information about a relying party. The reputation information can be stored locally or remotely (for example, at an identity provider or reputation service). A reputation information engine can be used to provide the reputation information to the user. The user can then use the reputation information in performing a transaction with the relying party.

### RELATED APPLICATION DATA

This patent application is a continuation-in-part of co-pending U.S. patent application Ser. No. 12/030,063, titled “INFO CARD SELECTOR RECEPTION OF IDENTITY PROVIDER BASED DATA PERTAINING TO INFO CARDS”, filed Feb. 12, 2008, which is a continuation-in-part of co-pending U.S. patent application Ser. No. 12/029,373, titled “VISUAL AND NON-VISUAL CUES FOR CONVEYING STATE OF INFORMATION CARDS, ELECTRONIC WALLETS, AND KEYRINGS”, filed Feb. 11, 2008, both of which are hereby incorporated by reference for all purposes. This patent application is a continuation-in-part of co-pending U.S. patent application Ser. No. 12/029,373, titled “VISUAL AND NON-VISUAL CUES FOR CONVEYING STATE OF INFORMATION CARDS, ELECTRONIC WALLETS, AND KEYRINGS”, filed Feb. 11, 2008, which is hereby incorporated by reference for all purposes. This patent application is also related to co-pending U.S. patent application Ser. No. 11/843,572, filed Aug. 22, 2007, co-pending U.S. patent application Ser. No. 11/843,638, filed August 22, 2007, and to co-pending U.S. patent application Ser. No. 11/843,640, filed Aug. 22, 2007, which claim the benefit of U.S. Provisional Patent Application Serial No. 60/895,325, filed Mar. 16, 2007, of U.S. Provisional Patent Application Ser. No. 60/895,312, filed Mar. 16, 2007, and of U.S. Provisional Patent Application Ser. No. 60/895,316, filed Mar. 16, 2007, all of which are all hereby incorporated by reference for all purposes.

### FIELD OF THE INVENTION

This invention pertains to on-line transactions, and more particularly to presenting users with information about the reputation of relying parties.

### BACKGROUND OF THE INVENTION

When a user interacts with sites on the Internet (hereafter referred to as “service providers” or “relying parties”), the service provider often expects to know something about the user that is requesting the services of the provider. The typical approach for a service provider is to require the user to log into or authenticate to the service provider's computer system. But this approach, while satisfactory for the service provider, is less than ideal to the user. First, the user must remember a username and password for each service provider who expects such information. Given that different computer systems impose different requirements, and the possibility that another user might have chosen the same username, the user might be unable to use the same username/password combination on each such computer system. (There is also the related problem that if the user uses the same username/password combination on multiple computer systems, someone who hacks one such computer system would be able to access other such computer systems.) Second, the user has no control over how the service provider uses the information it stores. If the service provider uses the stored information in a way the user does not want, the user has relatively little ability to prevent such abuse, or recourse after the fact.

To address this problem, new systems have been developed that allow the user a measure of control over the information stored about the user. Windows CardSpace™ (sometimes called CardSpace) is a Microsoft implementation of an identity meta-system that offers a solution to this problem. (Microsoft, Windows, and CardSpace are either registered trademarks or trademarks of Microsoft Corporation in the United States and/or other countries.) A user can store identity information with an identity provider the user trusts. When a service provider wants some information about the user, the user can control the release of information stored with the identity provider to the service provider. The user can then use the offered services that required the identity information.

But while the replying party has some information about the user's identity, the user has no information about the relying party—at least, no information that the user cannot find on his own. This can be a problem: some merchants do not make any reputation information available on their site, and other merchants control what reputation information is available, limiting the reputation information to only information that praises the merchant. And even if the merchant makes all reputation information available, the accuracy of the data can be questionable, as the merchant controls the reputation information.

A need remains for a way to addresses these and other problems associated with the prior art.

### SUMMARY OF THE INVENTION

In an embodiment of the invention, a system includes a reputation information engine. The reputation information engine is capable of providing reputation information to the user about the merchant. The user can then use the reputation information in using the system.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a sequence of communications between a client, a relying party, and an identity provider.

FIG. 2 shows a system to provide reputation information to a user, according to an embodiment of the invention.

FIG. 3 shows a system to provide reputation information to a user, according to a second embodiment of the invention.

FIG. 4 shows the client and identity provider in the system of FIG. 3 communicating via multiple channels.

FIGS. 5A-5B show a sequence of communications between a client, a relying party, an identity provider, and a reputation service.

FIG. 6 shows the client requesting reputation information from the reputation service of FIG. 3 in a manner that preserve's the user's privacy.

FIGS. 7A-7B show the transmission of reputation information that is protected against alteration in the system of FIG. 3.

FIG. 8 shows the system of FIG. 3 operating as a push model.

FIG. 9 shows the card selector of FIGS. 2 and 3 presenting the client with visual and/or non-visual cues.

FIG. 10 shows a flowchart of a procedure to provide reputation information to a user in the systems of FIGS. 2 and 3.

FIGS. 11A-11B show a flowchart of a procedure for a card selector to receive reputation information in the system of FIGS. 2 and 3.

FIG. 12 shows a flowchart of a procedure to use the reputation information to provide information to a user in the systems of FIGS. 2 and 3.

### DETAILED DESCRIPTION OF THE PREFERRED EMBODIMENT

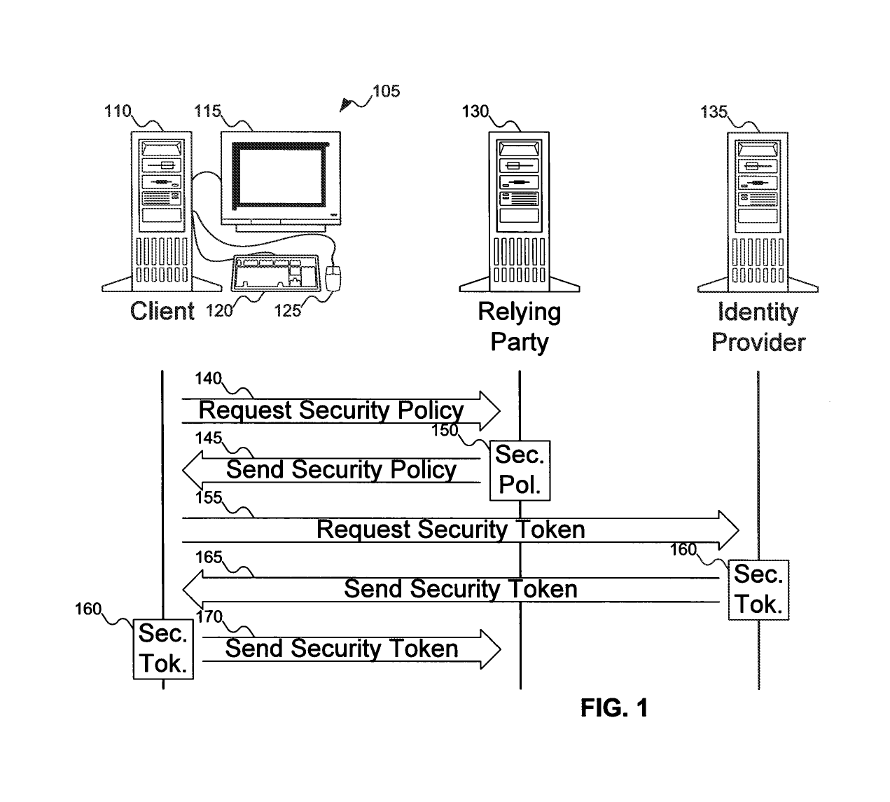

Co-pending U.S. patent application Ser. No. 12/030,063, titled “INFO CARD SELECTOR RECEPTION OF IDENTITY PROVIDER BASED DATA PERTAINING TO INFO CARDS”, filed Feb. 12, 2008, which is hereby incorporated by reference for all purposes, describes how an identity provider can provide metadata which can be used by the user for various purposes. One example of such metadata is reputation information about the relying party: for example, whether a relying party has previously been considered reliable by other users. While co-pending U.S. patent application Ser. No. 12/030,063, titled “INFO CARD SELECTOR RECEPTION OF IDENTITY PROVIDER BASED DATA PERTAINING TO INFO CARDS”, filed Feb. 12, 2008, could be used as is without modification (except to use reputation information as the metadata) to provide reputation information to a user, there are advantages to modifications of that system, as described herein Before explaining the invention, it is important to understand the context of the invention. FIG. 1 shows a sequence of communications between a client, a relying party, and an identity provider. For simplicity, each party (the client, the relying party, and the identity provider) can be referred to by their machines. Actions attributed to each party are taken by that party's machine, except where the context indicates the actions are taken by the actual party.

In FIG. 1, computer system 105, the client, is shown as including computer 110, monitor 115, keyboard 120, and mouse 125. A person skilled in the art will recognize that other components can be included with computer system 105: for example, other input/output devices, such as a printer. In addition, FIG. 1 does not show some of the conventional internal components of computer system 105; for example, a central processing unit, memory, storage, etc. Although not shown in FIG. 1, a person skilled in the art will recognize that computer system 105 can interact with other computer systems, such as relying party 130 and identity provider 135, either directly or over a network (not shown) of any type. Finally, although FIG. 1 shows computer system 105 as a conventional desktop computer, a person skilled in the art will recognize that computer system 105 can be any type of machine or computing device capable of providing the services attributed herein to computer system 105, including, for example, a laptop computer, a personal digital assistant (PDA), or a cellular telephone.

Relying party 130 is a machine managed by a party that relies in some way on the identity of the user of computer system 105. The operator of relying party 130 can be any type of relying party. For example, the operator of relying party 130 can be a merchant running a business on a website. Or, the operator of relying party 130 can be an entity that offers assistance on some matter to registered parties. Relying party 130 is so named because it relies on establishing some identifying information about the user.

Identity provider 135, on the other hand, is managed by a party responsible for providing identity information (or other such information) about the user for consumption by the relying party. Depending on the type of information identity provider 135 stores for a user, a single user might store identifying information with a number of different identity providers 135, any of which might be able to satisfy the request of the relying party. For example, identity provider 135 might be a governmental agency, responsible for storing information generated by the government, such as a driver's license number or a social security number. Or, identity provider 135 might be a third party that is in the business of managing identity information on behalf of users. It is worth noting that identity provider 135 stores the claims—the actual values of the identity information about the user; the information card stored on computer system 105 represents this information. The identity provider does not store the information cards themselves.

The conventional methodology of releasing identity information can be found in a number of sources. One such source is Microsoft Corporation, which has published a document entitled Introducing Windows CardSpace, which can be found on the World Wide Web at http://msdn2.microsoft.com/en-us/library/aa480189.aspx and is hereby incorporated by reference. To summarize the operation of Windows CardSpace, when a user wants to access some data from relying party 130, computer system 105 requests the security policy of relying party 130, as shown in communication 140, which is returned in communication 145 as security policy 150. Security policy 150 is a summary of the information relying party 130 needs, how the information should be formatted, and so on.

Once computer system 105 has security policy 150, computer system 105 can identify which information cards will satisfy security policy 150. Different security policies might result in different information cards being usable. For example, if relying party 130 simply needs a user's e-mail address, the information cards that can satisfy this security policy might be different from the information cards that satisfy a security policy requesting the user's full name, mailing address, and social security number. The user can then select an information card that satisfies security policy 150.

Once the user has selected an acceptable information card, computer system 105 uses the selected information card to transmit a request for a security token from identity provider 135, as shown in communication 155. This request can identify the data to be included in the security token, the credential that identifies the user, and other data the identity provider needs to generate the security token. Identity provider 135 returns security token 160, as shown in communication 165. Security token 160 includes a number of claims, or pieces of information, that include the data the user wants to release to the relying party. Security token 160 is usually encrypted in some manner, and perhaps signed and/or time-stamped by identity provider 135, so that relying party 130 can be certain that the security token originated with identity provider 135 (as opposed to being spoofed by someone intent on defrauding relying party 130). Computer system 105 then forwards security token 160 to relying party 130, as shown in communication 170.

In addition, the selected information card can be a self-issued information card: that is, an information card issued not by an identity provider, but by computer system 105 itself. In that case, identity provider 135 effectively becomes part of computer system 105.

In this model, a person skilled in the art will recognize that because all information flows through computer system 105, the user has a measure of control over the release of the user's identity information. Relying party 130 only receives the information the user wants relying party 130 to have, and does not store that information on behalf of the user (although it would be possible for relying party 130 to store the information in security token 160: there is no effective way to prevent such an act).

But, as noted above, there might be information—reputation information about the relying party—stored either locally or externally, such as on an identity provider or a reputation service, that might be of value to the user. If the user is not provided this reputation information, the user makes less than a fully-informed decision in selecting an information card. The user might be releasing potentially sensitive information to an untrustworthy relying party. This, it is important that the user be provided reputation information about the relying party, wherever it might be stored.

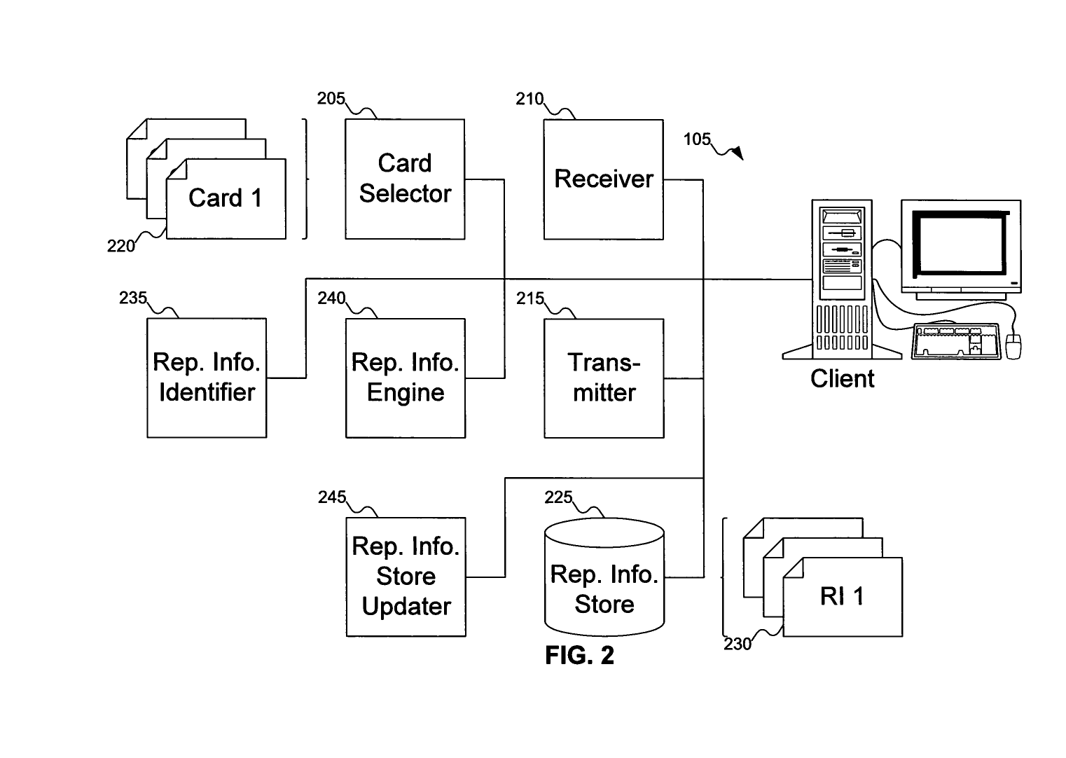

Now that the problem—providing reputation information to a user—is understood, a solution to the problem can be explained. FIG. 2 shows a system to provide reputation information to a user, according to an embodiment of the invention. In FIG. 2, computer system 105 includes card selector 205, receiver 210, and transmitter 215. Card selector 205 enables a user to select information card 220 that satisfies the security policy. Receiver 210 receives data transmitted to computer system 105, and transmitter 215 is transmits information from computer system 105. These components are the same as those found in computer system 105 as shown in FIG. 1.

Computer system 105 also includes reputation information store 225. Reputation information store 225 stores reputation information, such as reputation information 230, about relying parties, such as the relying party with whom the user wants to perform a transaction. Each piece of reputation information stored in reputation information store 225, such as reputation information 230, can be identified with an identifier such as reputation information identifier 235. Reputation information 230 can include an overall reputation for the relying party, or it can be subdivided by category (for example, to indicate that the relying party is very reliable in shipping purchased products that are in good condition and has a good “terms of use” policy, but has a poor reputation for keeping the user's privacy data private). Reputation information is not limited to just a raw number rating: reputation information 230 can include comments/remarks from other users who have reviewed the relying party.

Aside from what data reputation information 230 can represent, reputation information 230 can take any desired form. Among other possible forms, reputation information 230 can include a white list of known “good” relying parties, a black list of known “bad” relying parties, and a “shade of grey” list, which identifies known relying parties along the spectrum between “good” and “bad”. Reputation information 230 can also be, for example, a set of comments left by users.

Reputation information store 225 can also store reputation information metadata (not shown in FIG. 2). Reputation information metadata is data about the reputation information. Examples of such metadata can include the number of times the associated reputation information was viewed, when the associated reputation information was last reviewed, what others thought of the associated reputation information, whether the provider of the associated reputation information was verified (and if verified, to what extent) or was anonymous, etc. For example, one person might provide a review of a transaction with a relying party, which would be reputation information; what other people thought about that review, or when that review was last considered by another person, can be reputation information metadata. In all further discussion, reputation information 230 can also include reputation information metadata.

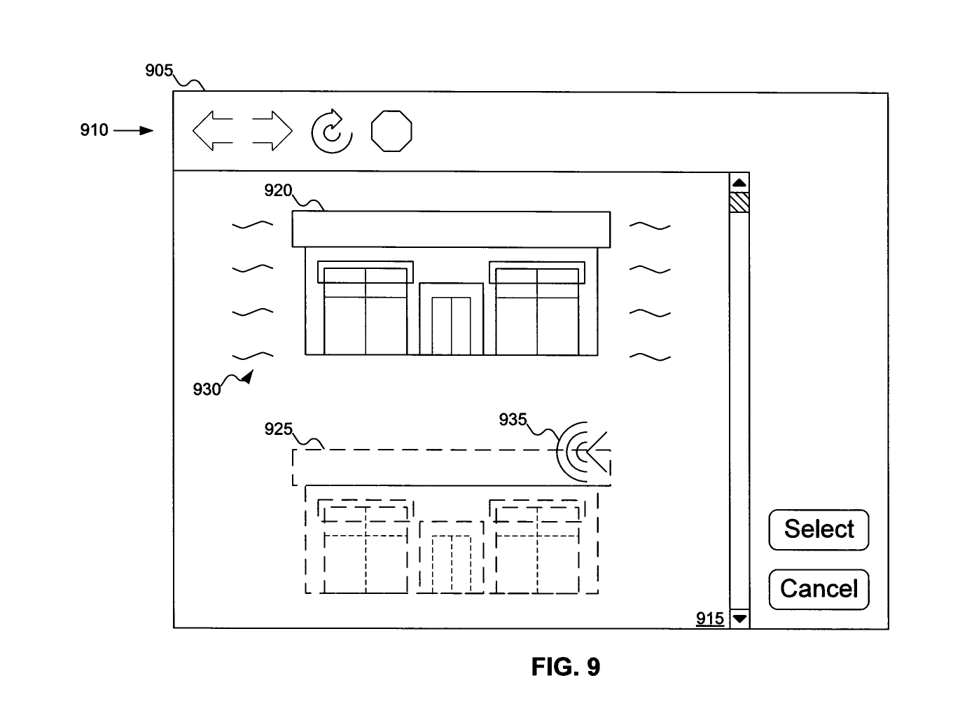

Computer system 105 also includes reputation information engine 240. Reputation information engine 240 processes reputation information 230 to present the reputation information to the user, and the form in which the reputation information can be presented. For example, if the information is heavily textual in nature (for example, written comments by a number of users who have interacted with the relying party), reputation information 230 can be presented to the user in some box or screen element, allowing the user to peruse the information at his or her leisure. But there are other ways in which the reputation information can be presented. One way in which reputation information 230 can be presented to the user is in the form of a visual or non-visual cue to the user. Co-pending U.S. patent application Ser. No. 12/029,373, titled “VISUAL AND NON-VISUAL CUES FOR CONVEYING STATE OF INFORMATION CARDS, ELECTRONIC WALLETS, AND KEYRINGS”, filed Feb. 11, 2008, which is incorporated by reference, describes how visual and non-visual cues can be used to present information to the user. A person skilled in the art will recognize that the system of co-pending U.S. patent application Ser. No. 12/029,373, titled “VISUAL AND NON-VISUAL CUES FOR CONVEYING STATE OF INFORMATION CARDS, ELECTRONIC WALLETS, AND KEYRINGS”, filed Feb. 11, 2008, can be modified so that instead of providing users with cues about information cards, the cues relate to the reputation of relying parties, as discussed below with reference to FIG. 9. For example, cues that generally reflect a positive state (such as a green traffic light, a smiley face, or a high numerical rating) can be used to inform the user that the relying party has a good reputation, whereas cues that generally reflect a negative state (such as a red traffic light, a frowning face, or a low numerical rating) can be used to inform the user that the relying party has a poor reputation.

Finally, computer system 105 includes reputation information store updater 245. Reputation information store updater 245 updates reputation information store 225. This update can be based on information provided by the user or any other source of information that affects the data stored in reputation information store 225.

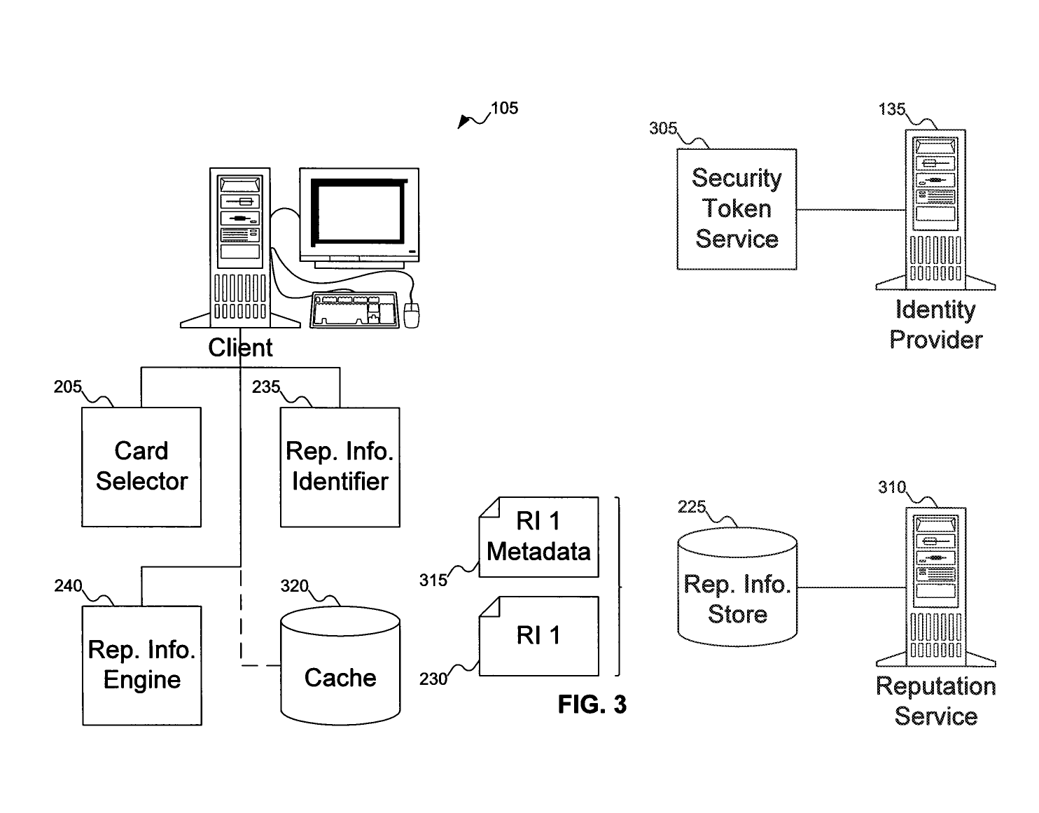

In the above described embodiments of the invention, it is assumed that all the pertinent information (such as the information cards and the reputation information) is stored on computer system 105. But this is not always the case. For example, users sometimes use identity providers to generate the security tokens for the relying party. In such a model, the claim information associated with the information card is not stored on computer system 105: computer system 105 only stores the information card, which is a representation of the information managed by the identity provider. In a similar manner, reputation information might be stored on machines other than computer system 105. FIG. 3 shows a system to provide reputation information to a user, where the information card claims (that is, the identity information requested by the relying party) and the reputation information are not stored on computer system 105.

In FIG. 3, computer system 105 still includes card selector 205, receiver 210, transmitter 215, reputation information engine 240, and reputation information identifier 235. Identity provider 135 includes security token service 305, which is responsible for issuing security token 160 (in FIG. 1), based on the identity information (not shown in FIG. 3) stored by identity provider 135. As with the system of FIG. 2, reputation information store 225 stores reputation information about relying parties. But in the embodiment of FIG. 3, reputation service 310, rather than computer system 105, includes reputation information store 225, which can include reputation information 230 and reputation information metadata 315.

In the system of FIG. 3, operation is basically the same as in the system of FIG. 2. But instead of locally accessing reputation information store 225, computer system 105 requests the reputation information from reputation information store 225 on reputation service 310. This request can take any desired form: for example, using a WS-* protocol or some other method.

When and how computer system 105 receives reputation information 230 (and/or reputation information metadata 315) from reputation service 315 depends on the implementation of the system. In one embodiment, computer system 105 can request reputation information 230 from reputation service 315 as soon as the identity of the relying party is known. In another embodiment, computer system 105 can request from reputation service 315 all reputation information 230 about any relying parties. But in such an embodiment, the information received from reputation service 315 can be significant in quantity, to the point of being more information than is useful (especially given the probability that reputation service 315 stores reputation information about a large number of relying parties that the user is not interested in).

While FIG. 3 shows identity provider 135 and reputation service 315 as separate machines, a person skilled in the art will recognize that identity provider 135 can act as a reputation service. In such an embodiment of the invention, identity provider 135 provides both functionalities, including both security token service 305 and reputation information store 225.

Reputation information engine 240 can manage reputation information in any desired manner appropriate to the embodiment of the invention. For example, in FIGS. 2-3, reputation information engine 240 can present reputation information 230 to the user as a forum (such as a bulletin board) where the individual pieces of reputation information can be users' comments and critiques. But a person skilled in the art will recognize that the system for managing the reputation information can take other forms. For example, co-pending U.S. patent application Ser. No. 11/682,783, titled “SYSTEM AND METHOD FOR PROVIDING REPUTATION RECIPROCITY WITH ANONYMOUS IDENTITIES”, filed Mar. 6, 2007, and co-pending U.S. patent application Ser. No. 12/022,518, titled “SYSTEM AND METHOD FOR EXPRESSING AND EVALUATING SIGNED REPUTATION ASSERTIONS”, filed Mar. 6, 2007, both of which are hereby incorporated by reference, describe systems for managing reputation information. Comparing these applications with the current invention, relying party 130 and client 105 can be the transacting parties (with either taking the role of the hesitant party and the unknown or unverified party), and a third party can act as the asserting party. For example, in the embodiment shown in FIG. 3, either reputation service 310 or identity provider 135 or both) can act as the asserting party, among other possibilities.

Reputation information engine 240 can also be implemented in a manner that provides client 105 with some sense of trust about the accuracy of reputation information 230. For example, reputation information engine 240 can be designed to authenticate the source of the reputation information, such as reputation service 310 in FIG. 3, before processing reputation information 230 and presenting that information to client 105. Reputation information engine 240 can also display some indication of the trustworthiness of the source of reputation information 230. While this display can include a standard logo, customizations are also possible. For example, client 105 can include a combination of a logo from the source of reputation information 230 with some data that is unique to client 105, such as a user-selected image, a user-selected modification to the source logo, animation or other visual or non-visual modification of the source logo, presenting the display in some location that is not directly accessible by the source of reputation information 230, and so on. By using such a modified logo, it becomes difficult for another entity to fraudulently present itself as the source of reputation information 230.

In embodiments of the invention where identity provider 135 also acts as reputation service 310, computer system 105 can interact with identity provider 135 in both of its separate capabilities. This fact opens the door to computer system 105 requesting reputation information 230 from identity provider 135 at different times, with potentially different results. In one embodiment, computer system 105 requests reputation information 230 from identity provider 135 at the same time that it requests the security token. In this embodiment, computer system 105 cannot inform the user about the reputation information before the user selects the information card, as the information card is selected before the security token is requested. But reputation information 230 can be stored locally (for example, in cache 320) for use by the user in the next transaction with that relying party.

In another embodiment, computer system 105 can request reputation information 230 from identity provider 135 in request that is out-of-band from a request for a security token. In this embodiment, because computer system 105 can request reputation information 230 before requesting the security token, computer system 105 can process the reputation information and let the user use that information in completing the transaction.

In yet another embodiment, computer system 105 can inform identity provider 135 (as the reputation service) that computer system 105 is online. This communication can be part of a broadcast from computer system 105 to a number of identity providers/reputation services. Then, identity provider 135, acting as a reputation service, can make a decision whether it has any reputation information that should be provided to computer system 105. If identity provider 135 has some reputation information to provide to computer system 105, identity provider 135 can transmit this reputation information to computer system 105 in an unsolicited communication. In this embodiment, the responsibility for the decision as to whether to transmit the reputation information lies with identity provider 135. Each reputation service can make this decision independently of any others.

In these embodiments where computer system 105 requests reputation information from identity provider 135 or reputation service 310, computer system 105 can request reputation information from each identity provider or reputation service when the system connects to the network (or at some regular intervals thereafter: for example, once per day). Computer system 105 then uses this information, however requested and whenever received, to update cache 320. A person skilled in the art will recognize other ways in which computer system 105 can update cache 320. A person skilled in the art will also recognize that these update policies mean that cache 320 might be out-of-date when card selector 205 accesses reputation information from cache 320. These concerns exist, but it is better to use accurate (if slightly out-of-date) information in the presentation of information cards than to not have the reputation information at all.

Not shown in FIG. 3 is reputation information store updater 245 (from FIG. 2). Where computer system 105 includes cache 320, reputation information store updater 245 can update cache 320, both based on actions taken by the user and based on reputation information received from identity provider 135 or reputation service 310.

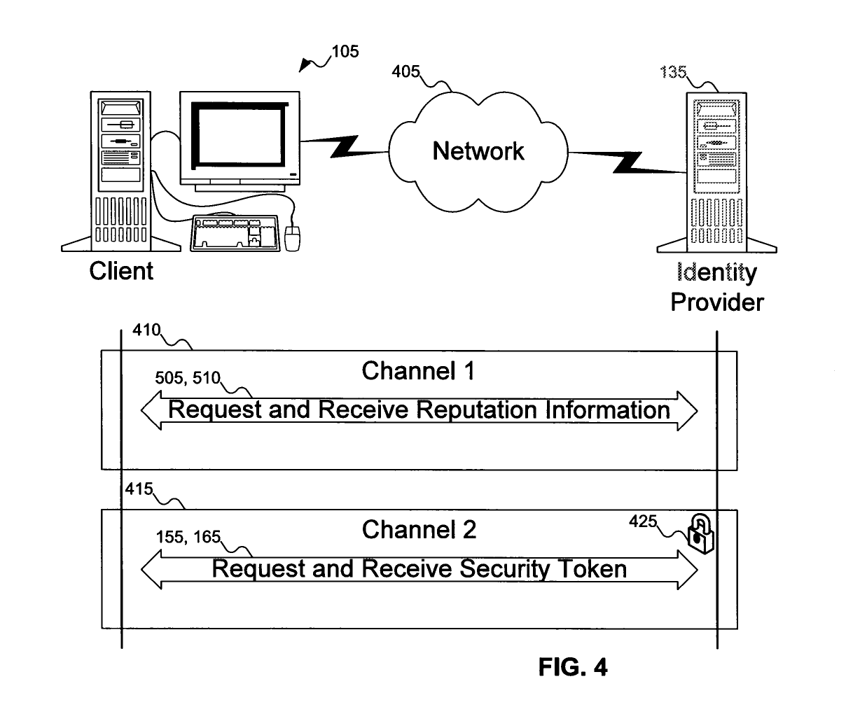

In situations where computer system 105 requests the reputation information from identity provider 135 separately from the request for the security token (which can be called an out-of-band request for the reputation information), there can be multiple channels used for communications between computer system 105 and identity provider 135. FIG. 4 shows the client and identity provider in the system of FIG. 3 communicating via multiple channels. A person skilled in the art will recognize that a channel can refer to multiple requests at different times along similar (or identical) paths between computer system 105 and identity provider 135, or that different paths can be used. In one embodiment, computer system 105 and identity provider 135 are both connected to a network, such as network 405. For example, network 405 can be a global network, such as the Internet. Alternatively, computer system 105 and identity provider 135 might be connected by other types of networks, such as a cellular network. (This embodiment might be used when the user is using a cellular telephone to authorize a transaction, with the card selector implemented on a cellular telephone or personal digital assistant.) In yet other embodiments, there can be multiple different types of networks connecting computer system 105 and identity provider 135.

A channel is a means of communication between computer system 105 and identity provider 135. A channel can include the physical constructs connecting computer system 105 and identity provider 135, the protocols used to manage the communication, and an identifier of a particular communication session between computer system 105 and identity provider 135, among other elements. For example, where both computer system 105 and identity provider 135 are connected to the Internet, the physical constructs between computer system 105 and identity provider 135 can include routers and cabling (or wireless routers, if some portion of the channel includes wireless communication). If a channel requires that communications travel between computer system 105 and identity provider 135 along a specific sequence of machines, this information form part of the definition of the channel. On the other hand, if the path between the machines is not critical, communications might travel along different paths, even while part of the same channel. Similarly, communications along different channels might include different protocols used to manage the message traffic. Finally, even if identical paths and protocols are used, communications between computer system 105 and identity provider 135 might involve different channels, if the communications are considered to be part of different sessions between the machines.

In FIG. 4 computer system 105 and identity provider 135 are shown communicating using two different channels. The specifics of what distinguish channel 410 from channel 415 can vary as discussed above, and are not important, beyond the fact that two different channels are being used. Channel 410 is shown as being used to manage the request for and receipt of the reputation information from identity provider 135, as shown in communication 420. Channel 415 is shown as being used to manage the request for a receipt of the security token from identity provider, as shown in communication 155. Because the security token contains important information about the user, channel 415 is encrypted, as shown by encryption icon 425. Channel 410 is not shown as encrypted, because the information being transmitted is not considered to be sensitive (hence the lack of an encryption icon in channel 410). But if the reputation information were considered sensitive, channel 410 could be encrypted as well.

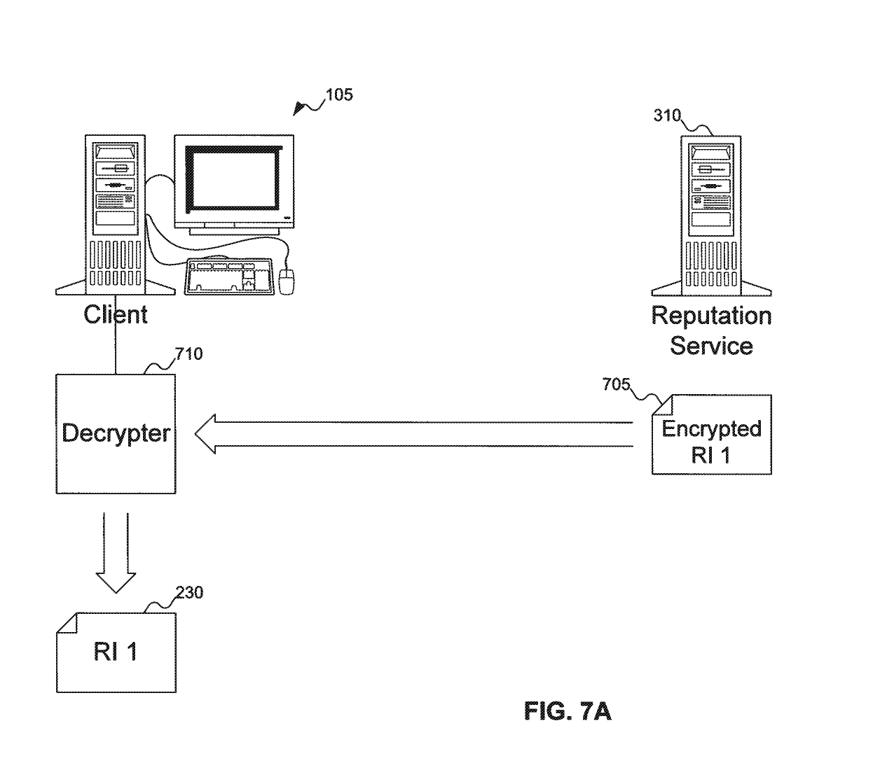

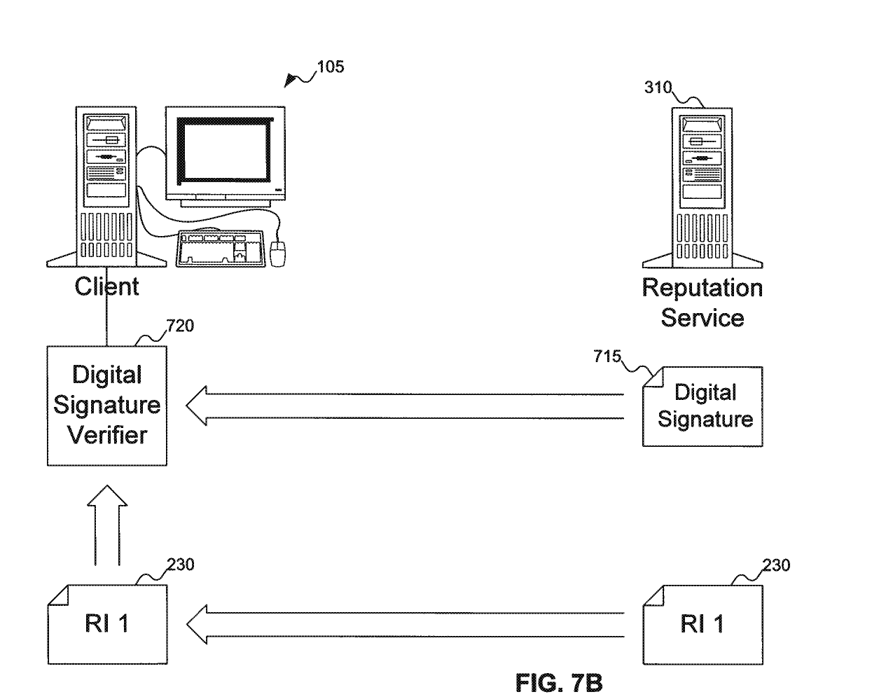

Reputation information might or might not be secret, but it is helpful that the reputation information not be altered. One way in which alteration of the reputation information can be detected is if the reputation information is encrypted. Another way in which alteration of the reputation information can be detected is if the reputation information is digitally signed. These embodiments are discussed further with reference to FIGS. 7A-7B below. A person skilled in the art will recognize other ways in which the client can verify that the reputation information is not altered, to enable the client to detect whether anyone has tampered with the reputation information (i.e., to make the reputation information “tamper-proof”): for example, by using a checksum on the reputation information.

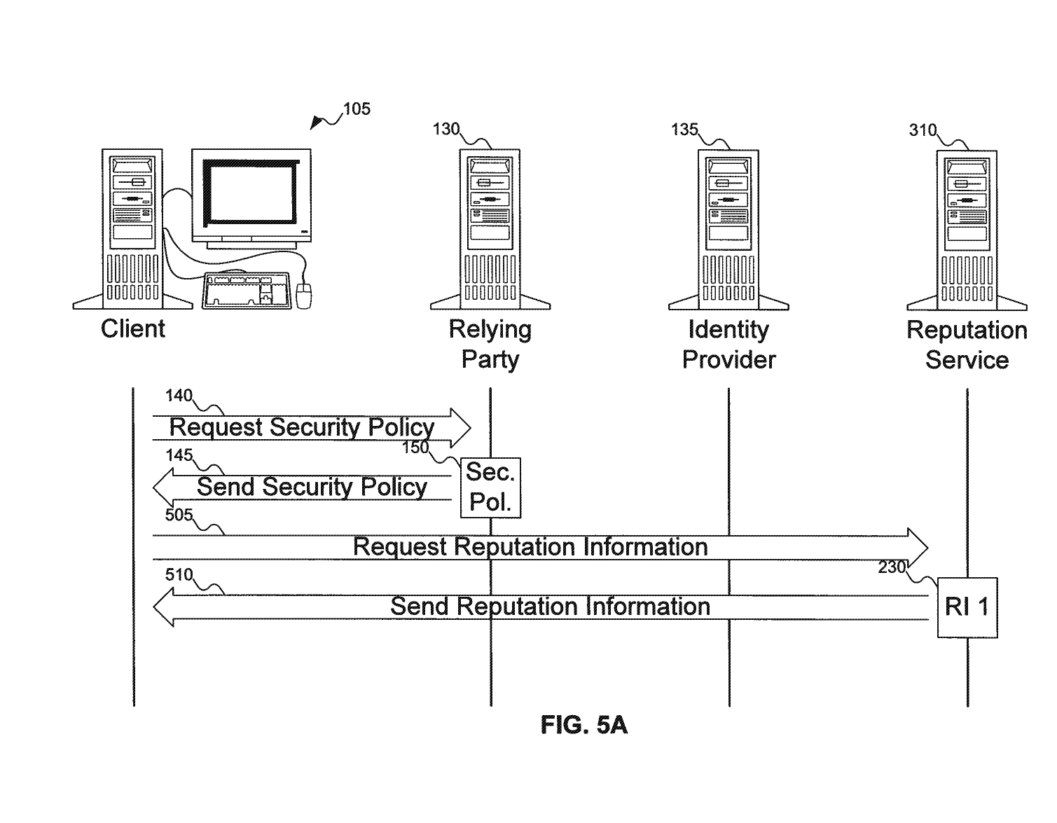

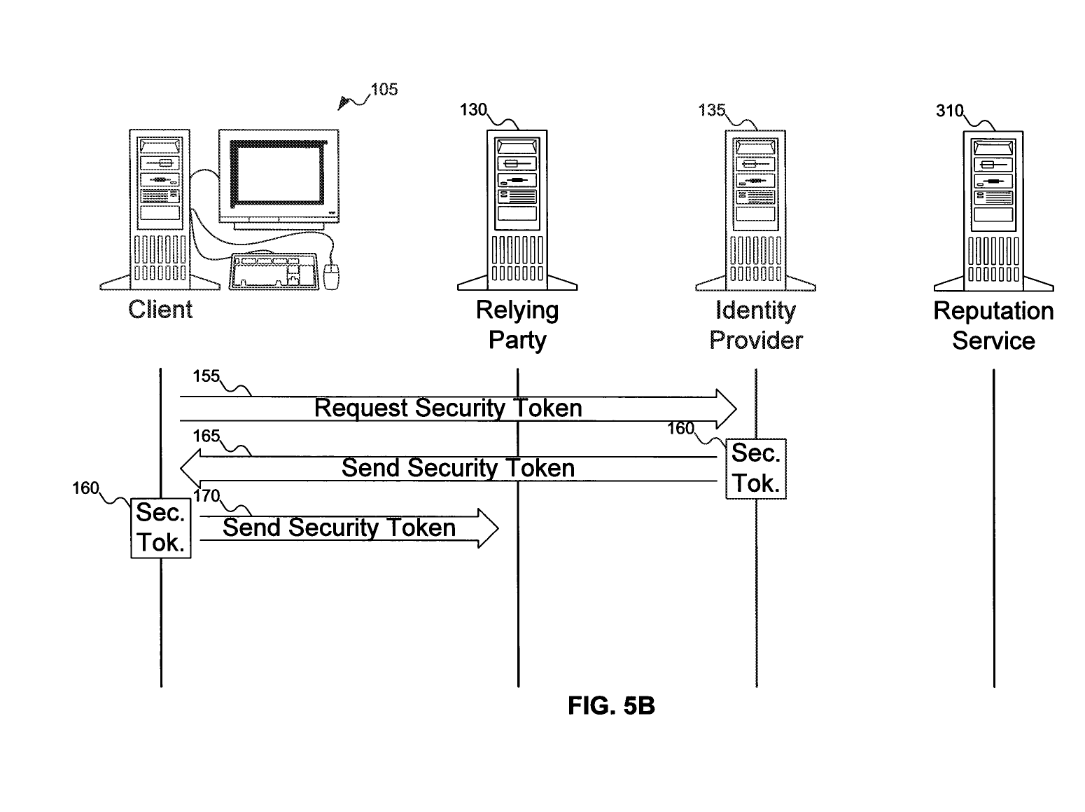

Now that the operation of embodiments of the invention, such as those shown in FIGS. 2 and 3, is described, the sequence of communications between the client and the various parties can be explained. FIGS. 5A-5B show a sequence of communications between a client, a relying party, an identity provider, and a reputation service. In FIG. 5A, computer system 105 requests and receives security policy 150 from relying party 130, as before. Computer system 105 can then request reputation information about the relying party from reputation service 310, as shown in communication 505. Computer system 105 receives reputation information 230, as shown in communication 510. Computer system can then request and receive security token 160 from identity provider 135, and provide security token 160 to relying party 130, as before (as shown in FIG. 5B).

Where computer system 105 requests metadata generally from identity provider 135 (as described in co-pending U.S. patent application Ser. No. 12/030,063, titled “INFO CARD SELECTOR RECEPTION OF IDENTITY PROVIDER BASED DATA PERTAINING TO INFO CARDS”, filed Feb. 12, 2008), the sensitivity of the information might or might not be considered important. But reputation information might be sufficiently important that a user would want to protect its use. For example, if computer system 105 requests information about a specific relying party, the obvious conclusion is that the user is considering a transaction with that relying party. If the relying party is known to focus on a particular product or service, the user might find himself or herself subject to advertising by other companies regarding that product or service. If the user does not want such advertising, the user would have to choose between forgoing the use of the reputation information or potentially losing some privacy relating to the transaction with the relying party.

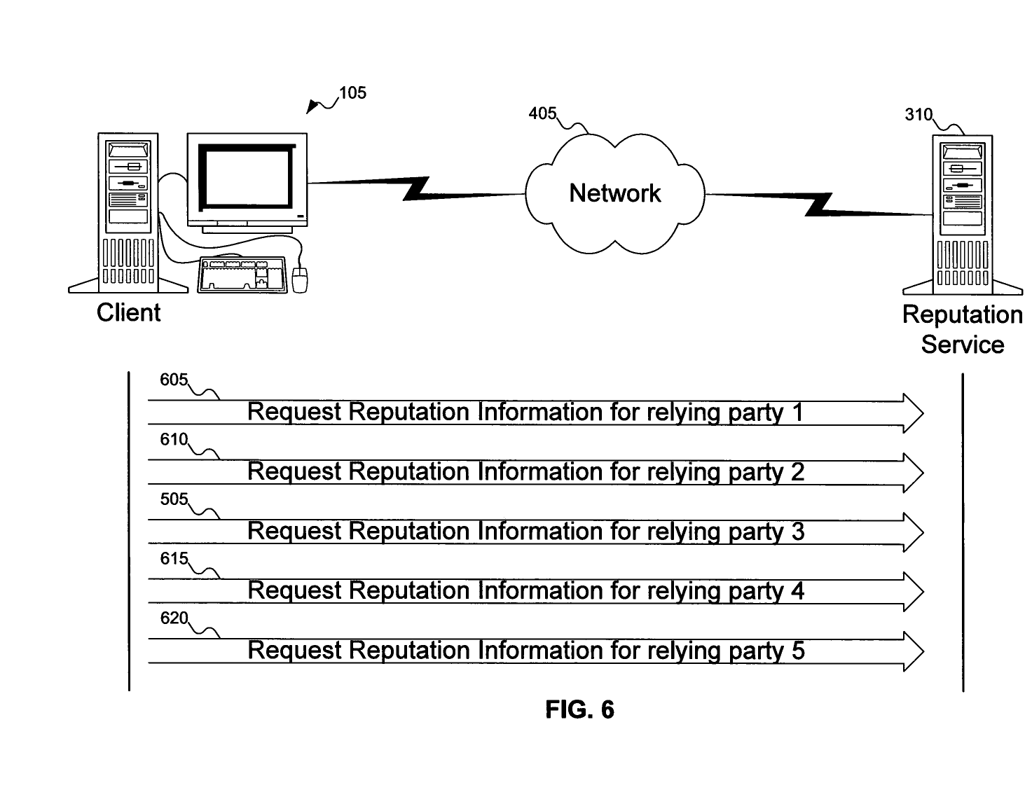

In one embodiment of the invention, to protect the user's privacy, computer system 105 can “disguise” the relying party that is of interest by requesting reputation information about a number of different relying parties. FIG. 6 shows this embodiment in action. In FIG. 6, computer system 105 is shown as sending to reputation service 310 five requests for reputation information, in communications 605, 610, 615, 620, and 625. (FIG. 6 does not show the replies from reputation service 310, but a person skilled in the art will recognize that the replies can be sent at any time after the request, and be interleaved with the requests in any order.) Only one of these requests identifies the relying party with which the user is interested in performing a transaction; the other requests are dummies, and their replies can be discarded by computer system 105. While FIG. 6 shows five such requests, a person skilled in the art will recognize that any number of requests can be used to disguise the relying party of interest. In this manner, reputation service 310 does not know which relying party was the actual subject of the request.

There are many different ways in which the “dummy” relying parties can be identified. Computer system 105 can access a list of relying parties, and pick a number of them at random. Or, computer system 105 can filter the list, perhaps only selecting relying parties that provide comparable services or products (although such a mechanism might give away some of the user's anonymity, in that it would identify a product or service the user is potentially interested in). Or, computer system 105 can make up some relying party names at random (although this, too, might give away some anonymity, in that the relying party of interest might be the only real relying party in the list). A person skilled in the art will recognize other ways in which computer system 105 can select relying parties to use in attempting to preserve the user's anonymity, along with other techniques that can be used to preserve anonymity.

FIGS. 7A-7B show the transmission of reputation information that is protected against alteration in the system of FIG. 3. In FIG. 7A, reputation service 310 is shown as transmitting encrypted reputation information 705 to client 105. This can occur if reputation information 230 includes sensitive information that the user might not want to be publicized. In this embodiment, client 105 can include decrypter 710, which can decrypt encrypted reputation information 705, to retrieve reputation information 230. To be able to properly decrypt encrypted reputation information 705, client 105 and reputation service 310 need to agree on the parameters of encryption: a person skilled in the art will recognize how different forms of encryption can be used to encrypt metadata 230 to encrypted reputation information 705.

In another embodiment, as shown in FIG. 7B, reputation service 310 is shown as transmitting reputation information 230 to client 105, along with digital signature 715. In this embodiment, client 105 can include digital signature verifier 720, which can verify that digital signature 715 corresponds to reputation information 230. In this manner, client 105 can verify that reputation information 230 was not altered in transit; if reputation information 230 were altered or otherwise tampered with, digital signature 715 would not match, and client 105 would know to discard reputation information 230 as having been altered. A person skilled in the art will recognize other ways in which client 105 can verify that reputation information 230 has not been tampered with: for example, by verification of a checksum associated with reputation information 230.

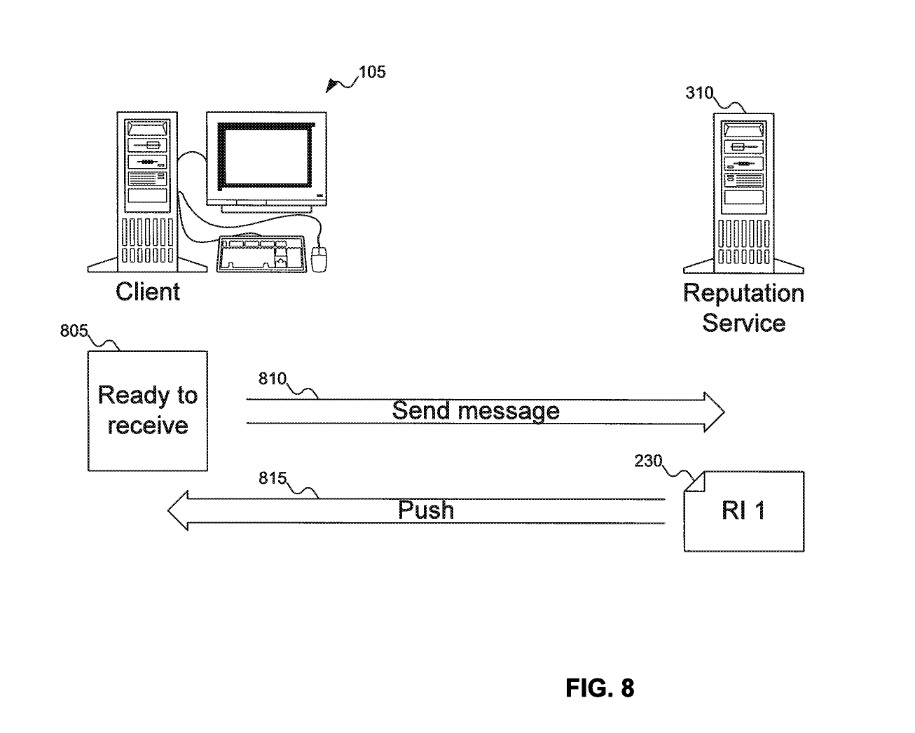

As discussed above with reference to FIG. 3, in one embodiment computer system 105 informs reputation service 310 that it is available, and let reputation service 310 decide when to provide reputation information 230 to computer system 105. This model, where the recipient of the information is not necessarily expecting it, is sometimes called a push model. FIG. 8 shows the system of FIG. 3 operating as a push model. In FIG. 8, computer system 105 sends message 805, informing reputation service 310 that computer system 105 is ready to receive reputation information, to reputation service 310, shown as communication 810. Then, when reputation service 310 is ready to transmit reputation information 230, reputation service 310 pushes reputation information 230 to computer system 105, shown as communication 815. Because reputation information 230 is not sent in a response to a specific request (nor necessarily at a time that suggests reputation information 230 is being sent responsive to message 805), reputation information 230 is being pushed to computer system 105.

As discussed above with reference to FIG. 2, one way in which reputation information can be presented to the user is using visual and/or non-visual cues. FIG. 9 shows the card selector of FIGS. 2 and 3 presenting the client with visual and/or non-visual cues concerning reputation information. In FIG. 9, screen 905 shows what card selector 205 might display to the user. Among other options, screen 905 can include navigation buttons 910, to permit the user to navigate around within card selector 205. Screen 905 can also include a main area 915, where cards can be displayed to the user.

In main area 915, two relying parties 920 and 925 are shown. Relying party 920 is represented with “stink lines” 930, which are a visual representation that relying party 920 is no longer “fresh”. “Stink lines” 930 can be static, or can “shimmer” on screen, as desired. “Stink lines” 930 can be used to represent that there is a problem with relying party 920: for example, that relying party 920 does not have a good reputation. A person skilled in the art will recognize other possible visual cues, some of which are described in co-pending U.S. patent application Ser. No. 12/029,373, titled “VISUAL AND NON-VISUAL CUES FOR CONVEYING STATE OF INFORMATION CARDS, ELECTRONIC WALLETS, AND KEYRINGS”, filed Feb. 11, 2008, which is incorporated by reference herein.

Aside from visual cues, card selector 205 can also preset to the user non-visual cues regarding the state of relying parties. For example, relying party 925 is “shown” with aural sound 935. Aural sound 935 is an aural cue to the user regarding the state of relying party 925. For example, aural information might be a siren sound, alerting the user to a problem with the relying party. Other non-visual cues can include beeps, spoken warning or information messages, and so on. A person skilled in the art will recognize other possible aural cues.

Cues can take other forms as well, such as olfactory or tactile. For example, given the appropriate technology, card selector 205 might use a smell generator to release a “rotten egg”-type smell for a relying party that is does not have a good reputation (i.e., that “stinks”). Or, the user's keyboard might get hotter when the user is visiting a relying party whose reputation is poor. A person skilled in the art will recognize other ways in which card selector 205 can present non-visual cues to the user regarding the reputation of a relying party.

Although the above example uses cues of different types, which permits multiple different types of cues (aural vs. visual) to be applied simultaneously, this does not mean that cues of the same type cannot be used simultaneously. For example, a relying party might be colored red (to indicate it does not deliver products in a timely manner) and have stink lines (to indicate that it does not preserve user privacy). Or the relying party might “phase” between different cues (that is, alternate between the two cues, and gradually changing between the them), so that the user can be presented with both cues in a situation where one cue, if applied all the time, would prevent the presentation of another cue. A person skilled in the art will recognize other ways in which cues can be combined.

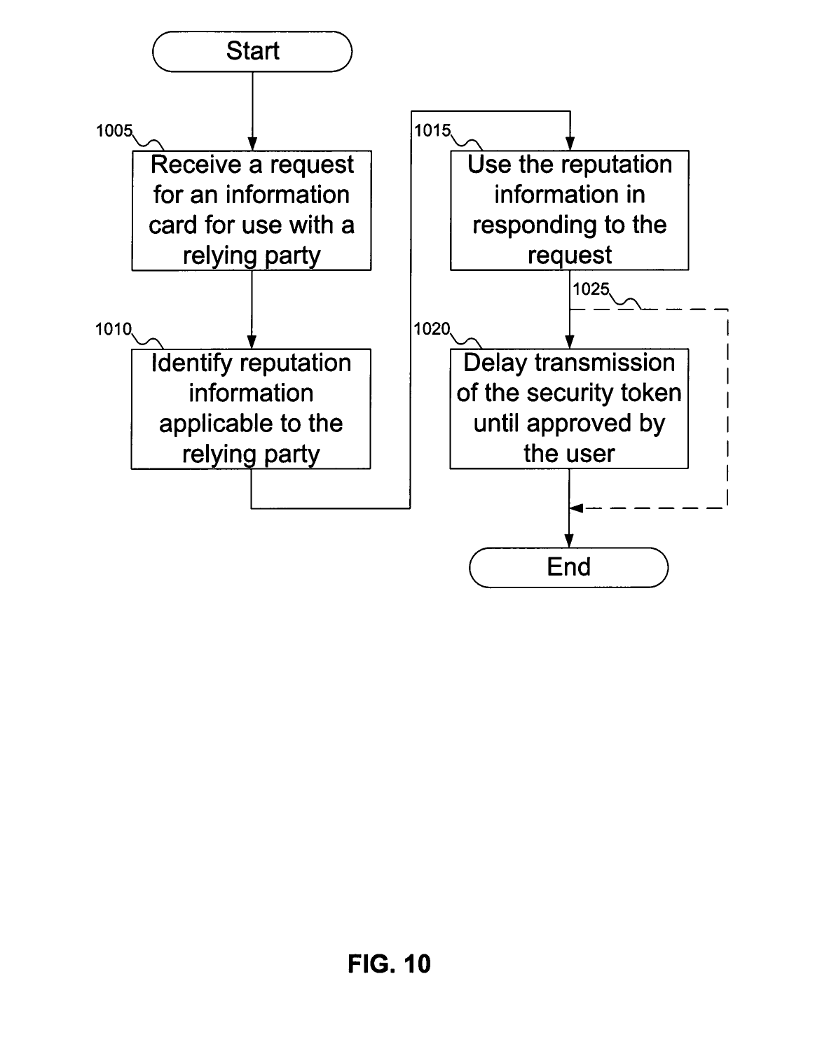

FIG. 10 shows a flowchart of a procedure to provide reputation information to a user in the systems of FIGS. 2 and 3. In FIG. 10, at block 1005, the system receives a request for an information card to use in a transaction with a relying party. At block 1010, the system identifies reputation information applicable to the relying party. At block 1015, the system uses the reputation information in responding to the request for an information card. This response can be to provide information to the user, to help identify the most appropriate information card to use (for example, to select an information card whose data is less important when the relying party has a poor reputation for managing privacy data), or to block the transaction outright. At block 1020, the system can delay the transmission of the security token to the relying party until approved by the user: for example, after reviewing the reputation information. Block 1020 can be skipped, as shown by dashed line 1025.

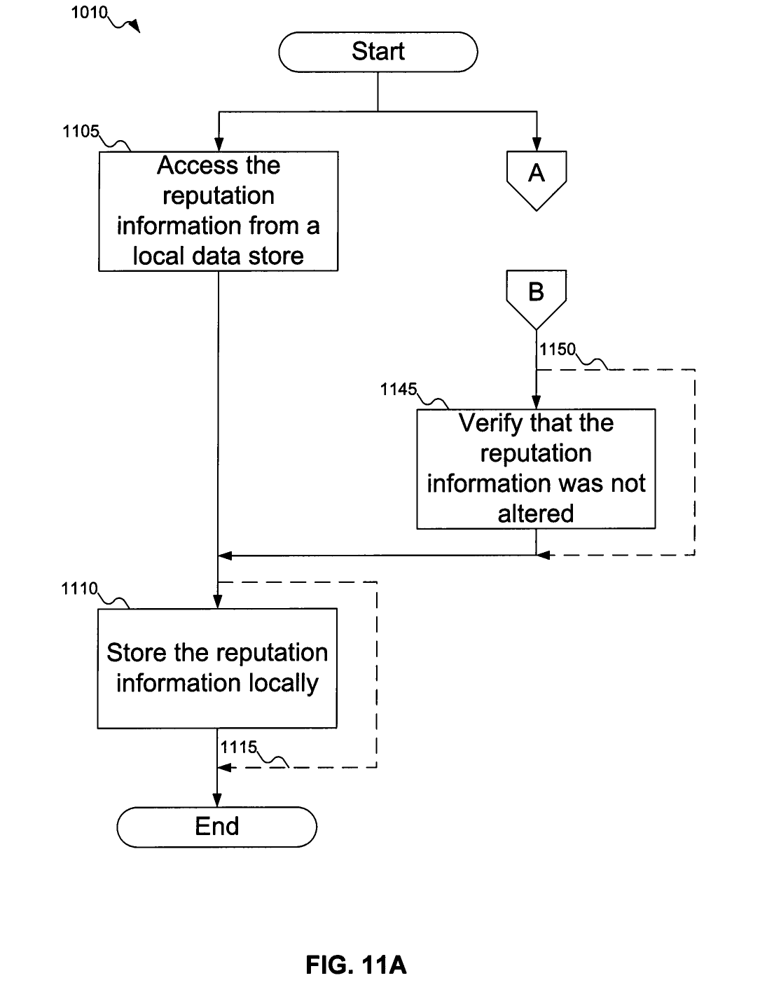

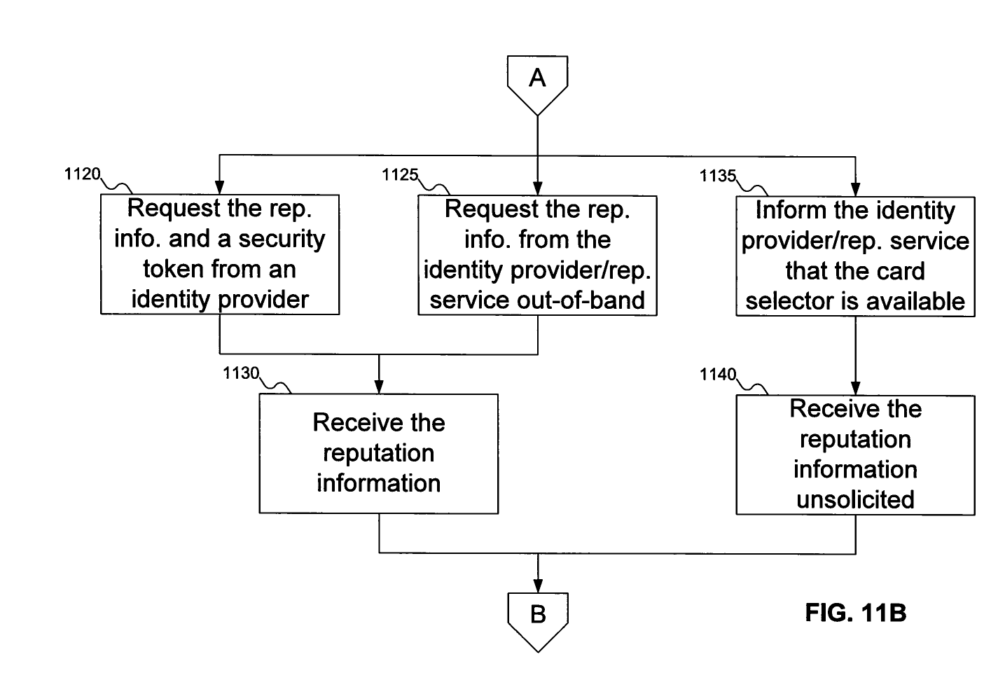

FIGS. 11A-11B show a flowchart of a procedure for a card selector to receive reputation information in the system of FIGS. 2 and 9. On FIG. 11A, at block 1105, if the reputation information is stored locally, the system can access the reputation information from the local data store. Then, at block 1110, the system can update the local data store, if needed (for example, if the user provides a rating for the relying party based on the current transaction). The system does not need to store the reputation information locally: block 1110 is optional, as shown by arrow 1115.

On the other hand, if the reputation information is received from an external source, such as an identity provider or reputation service, then at block 1120 (on FIG. 1B) the system can request the reputation information from the identity provider along with a request for a security token. While in this embodiment the reputation information would not be used to aid in processing the current request for an information card (as discussed above with reference to FIGS. 3-8), a person skilled in the art will recognize that the reputation information can be used in a later transaction with the relying party. In another embodiment, the system can request the reputation information from the identity provider or reputation service in an out-of-band request, as shown in block 1125. In either of these embodiments, at block 1130, the system can receive the reputation information: depending on the embodiment, the system can receive the reputation information in parallel with the security token or not.

In yet another embodiment, such as the push model discussed above with reference to FIG. 8, the system can inform the identity provider or reputation service that it is available, as shown in block 1135. If the identity provider or reputation service has reputation information to push to the system, then at block 1140 the system can receive the reputation information in an unsolicited communication.

In any embodiment where the system receives the reputation information from the identity provider or reputation service, if the reputation information was encrypted or otherwise protected against alteration (for example, by having an associated digital signature also transmitted to the client), then the system can verify the integrity of the reputation information, as shown in block 1145 (on FIG. 11A). As shown by arrow 1150, block 1145 is optional, and can be omitted. The system can also store the reputation information in a local data store, as shown in block 1110; again, block 1110 is optional, as shown by arrow 1115.

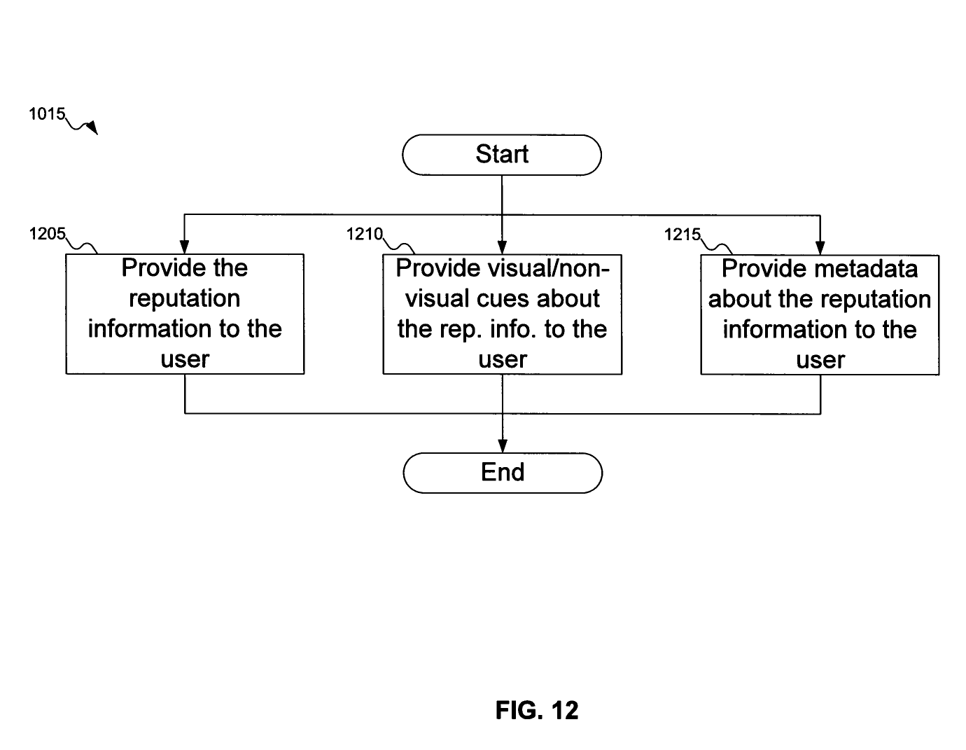

FIG. 12 shows a flowchart of a procedure to use the reputation information to provide information to a user in the systems of FIGS. 2 and 3. At block 1205, the system can provide the reputation information to the user. At block 1210, the system can use the reputation information to provide the user with visual and/or non-visual cues about the relying party's reputation. At block 1215, the system can provide the user with metadata about the reputation information.

The following discussion is intended to provide a brief, general description of a suitable machine in which certain aspects of the invention can be implemented. Typically, the machine includes a system bus to which is attached processors, memory, e.g., random access memory (RAM), read-only memory (ROM), or other state preserving medium, storage devices, a video interface, and input/output interface ports. The machine can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine can include embedded controllers, such as programmable or non-programmable logic devices or arrays, Application Specific Integrated Circuits, embedded computers, smart cards, and the like. The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

The invention can be described by reference to or in conjunction with associated data including functions, procedures, data structures, application programs, instructions, etc. which, when accessed by a machine, result in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, and other tangible, physical storage media. Associated data can also be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as can come within the scope and spirit of the following claims and equivalents thereto.

1. An apparatus, comprising:
a receiver (210) at a card selector (205) to receive a request for an information card (220) to be used in a transaction with a relying party (130);
an identifier (235) to identify reputation information (230) applicable to said relying party (130); and
a reputation information engine (240) to use said reputation information (230) in support of a response from said card selector (205) to said request for said information card (220).

2. An apparatus according to claim 1, wherein the receiver (210) is operative to receive (510) said reputation information (230) from a reputation service (310).

3. An apparatus according to claim 2, wherein said reputation service (310) is part of an identity provider (135).

4. An apparatus according to claim 2, further comprising a transmitter (215) to transmit a request (505) for said reputation information (230) to said reputation service (310) from said card selector (205).

5. An apparatus according to claim 4, wherein the transmitter (215) is operative to transmit said request (505) for said reputation information (230) to said reputation service (310) in a manner that preserves a user's privacy.

6. An apparatus according to claim 5, wherein the transmitter (215) is further operative to transmit said request (505) for said reputation information (230) applicable to said relying party (130) to said reputation service (310) as part of a plurality of requests (605, 610, 615, 620, 625) for reputation information (230) applicable to a plurality of replying parties.

7. An apparatus according to claim 4, wherein:
said reputation information (230) is part of an identity provider (135); and
the transmitter (215) is operative to transmit said request (505) for said reputation information (230) in a request (155) for a security token (160) from said identity provider (135).

8. An apparatus according to claim 4, wherein:
said reputation information (230) is part of an identity provider (135); and
the transmitter (215) is operative to transmit said request (505) for said reputation information (230) from said identity provider (135) in a request (505) that is out-of-band from a second request (155) for a security token (160) from said identity provider (135).

9. An apparatus according to claim 2, wherein the apparatus is operative to verify that said reputation information (230) is not altered.

10. An apparatus according to claim 9, wherein:
the receiver (210) is operative to receive encrypted reputation information (705) from said reputation service (310); and
the apparatus further comprises a decrypter (710) to decrypt said encrypted reputation information (705).

11. An apparatus according to claim 9, wherein:
the receiver (210) is operative to receive a digital signature (715) associated with said reputation information (230) from said reputation service (310); and
the apparatus further comprises a digital signature verifier (720) to verify that said digital signature (715) corresponds to said reputation information (230).

12. An apparatus according to claim 2, wherein the receiver (210) is operative to receive (510) said reputation information (230) in an unsolicited communication (815) from said reputation service (310).

13. An apparatus according to claim 12, further comprising a transmitter (215) to transmit a message (805) to said reputation service (310) that said card selector (205) is available to receive (510) said reputation information (230) from said reputation service (310).

14. An apparatus according to claim 2, further comprising a reputation information store (225, 320) to store said reputation information (230) locally to said card selector (205).

15. An apparatus according to claim 1, wherein the reputation information engine (240) is operative to provide said reputation information (230) to a user.

16. An apparatus according to claim 15, wherein the reputation information engine (240) is further operative to provide said user visual and/or non-visual cues (930, 935) regarding said reputation information (230) applicable to said relying party (130).

17. An apparatus according to claim 15, wherein the reputation information engine (240) is further operative to provide metadata (315) about said reputation information (230) to said user.

18. An apparatus according to claim 15, wherein the reputation information engine (240) is further operative to provide said reputation information (230) to said user before said user selects said information card (220) to be used in said transaction with said relying party (130).

19. An apparatus according to claim 15, wherein the reputation information engine (240) is further operative to delay transmission of a security token (160) received from an identity provider (135) to said relying party (130) until a release of said security token (160) is confirmed by said user after presentation of said reputation information (230).

20. An apparatus according to claim 1, wherein:
the apparatus further comprises a reputation information store (225) to store said reputation information (230); and
the reputation information engine (240) is operative to access said reputation information (230) from the reputation information store (225).

21. An apparatus according to claim 1, further comprising a reputation information store (225) updater to update a reputation information store (225, 320) local to said card selector (205) that stores said reputation information (230) applicable to said relying party (130).

22. A method for using reputation information (230), comprising:
receiving (1005) at a card selector (205) a request for an information card (220) to be used in a transaction with a relying party (130);
identifying (1010) reputation information (230) applicable to the relying party (130); and
using (1015) the reputation information (230) to support a response from the card selector (205) to the request for the information card (220).

23. A method according to claim 22, wherein identifying (1010) reputation information (230) applicable to the relying party (130) includes receiving (1130, 1140) the reputation information (230) from a reputation service (310).

24. A method according to claim 23, wherein receiving (1130, 1140) the reputation information (230) from a reputation service (310) includes receiving (1130, 1140) the reputation information (230) from an identity provider (135).

25. A method according to claim 24, wherein receiving (1130, 1140) the reputation information (230) from an identity provider (135) includes requesting (1120) the reputation information (230) from the identity provider (135) in a request (155) for a security token (160) from the identity provider (135).

26. A method according to claim 24, wherein receiving (1130, 1140) the reputation information (230) from an identity provider (135) includes requesting (1125) the reputation information (230) from the identity provider (135) in a request (505) that is out-of-band from a second request (155) for a security token (160) from the identity provider (135).

27. A method according to claim 23, wherein receiving (1130, 1140) the reputation information (230) includes requesting (1120, 1125, 1135) the reputation information (230) from the reputation service (310) by the card selector (205).

28. A method according to claim 27, wherein requesting (1120, 1125, 1135) the reputation information (230) includes requesting (1120, 1125, 1135) the reputation information (230) from the reputation service (310) by the card selector (205) in a manner that preserves a user's privacy.

29. A method according to claim 28, wherein requesting (1120, 1125, 1135) the reputation information (230) includes requesting (1120, 1125, 1135) the reputation information (230) applicable to the relying party (130) as part of a plurality of requests (605, 610, 615, 620, 625) for reputation information (230) applicable to a plurality of replying parties.

30. A method according to claim 23, wherein receiving (1130, 1140) the reputation information (230) from a reputation service (310) includes verifying (1145) that the reputation information (230) is not altered.

31. A method according to claim 30, wherein:
receiving (1130, 1140) the reputation information (230) from a reputation service (310) includes receiving (1130, 1140) an encrypted reputation information (705) from the reputation service (310); and
verifying (1145) that the reputation information (230) is not altered includes decrypting (1145) the encrypted reputation information (705).

32. A method according to claim 30, wherein:
receiving (1130, 1140) the reputation information (230) from a reputation service (310) includes receiving (1130, 1140) a digital signature (715) from the reputation service (310); and
verifying (1145) that the reputation information (230) is not altered includes verifying (1145) that the digital signature (715) corresponds to the reputation information (230).

33. A method according to claim 23, wherein receiving (1130, 1140) the reputation information (230) includes receiving (1140) the reputation information (230) from the reputation service (310) in an unsolicited communication (815) from the reputation service (310).

34. A method according to claim 33, wherein receiving (1140) the reputation information (230) from the reputation service (310) in an unsolicited communication (815) includes informing (1135) the reputation service (310) that the card selector (205) is available to receive reputation information (230) from the reputation service (310).

35. A method according to claim 23, wherein identifying (1010) reputation information (230) applicable to the relying party (130) further includes storing (1110) the reputation information (230) locally to the card selector (205).

36. A method according to claim 22, wherein using (1015) the reputation information (230) includes providing (1205) the reputation information (230) to a user.

37. A method according to claim 36, wherein providing (1205) the reputation information (230) to the user includes providing (1210) the user visual and/or non-visual cues (930, 935) regarding the reputation information (230) applicable to the relying party (130).

38. A method according to claim 36, wherein providing (1205) the reputation information (230) to the user includes providing (1215) metadata (315) about the reputation information (230) to the user.

39. A method according to claim 36, wherein providing (1205) the reputation information (230) to the user includes providing (1205) the reputation information (230) to the user before the user selects the information card (220) to be used in the transaction with the relying party (130).

40. A method according to claim 36, wherein providing (1205) the reputation information (230) to the user includes delaying (1020) transmission of a security token (160) received from an identity provider (135) to the relying party (130) until a release of the security token (160) is confirmed by the user after presentation of the reputation information (230).

41. A method according to claim 22, wherein identifying (1010) reputation information (230) applicable to the relying party (130) includes accessing (1105) a reputation information store (225, 320) local to the card selector (205).

42. A method according to claim 22, further comprising updating (1110) a local reputation information store (225, 320) containing the reputation information (230) based on the request for the information card (220).

43. An article, comprising a storage medium, said storage medium having stored thereon instructions that, when executed by a machine, result in:
receiving (1005) at a card selector (205) a request for an information card (220) to be used in a transaction with a relying party (130);
identifying (1010) reputation information (230) applicable to the relying party (130); and
using (1015) the reputation information (230) to support a response from the card selector (205) to the request for the information card (220).

44. An article according to claim 43, wherein identifying (1010) reputation information (230) applicable to the relying party (130) includes receiving (1130, 1140) the reputation information (230) from a reputation service (310).

45. An article according to claim 44, wherein receiving (1130, 1140) the reputation information (230) from a reputation service (310) includes receiving (1130, 1140) the reputation information (230) from an identity provider (135).

46. An article according to claim 45, wherein receiving (1130, 1140) the reputation information (230) from an identity provider (135) includes requesting (1120) the reputation information (230) from the identity provider (135) in a request (155) for a security token (160) from the identity provider (135).

47. An article according to claim 45, wherein receiving (1130, 1140) the reputation information (230) from an identity provider (135) includes requesting (1125) the reputation information (230) from the identity provider (135) in a request (505) that is out-of-band from a second request (155) for a security token (160) from the identity provider (135).

48. An article according to claim 44, wherein receiving (1130, 1140) the reputation information (230) includes requesting (1120, 1125, 1135) the reputation information (230) from the reputation service (310) by the card selector (205).

49. An article according to claim 48, wherein requesting (1120, 1125, 1135) the reputation information (230) includes requesting (1120, 1125, 1135) the reputation information (230) from the reputation service (310) by the card selector (205) in a manner that preserves a user's privacy.

50. An article according to claim 49, wherein requesting (1120, 1125, 1135) the reputation information (230) includes requesting (1120, 1125, 1135) the reputation information (230) applicable to the relying party (130) as part of a plurality of requests (605, 610, 615, 620, 625) for reputation information (230) applicable to a plurality of replying parties.

51. An article according to claim 44, wherein receiving (1130, 1140) the reputation information (230) from a reputation service (310) includes verifying (1145) that the reputation information (230) is not altered.

52. An article according to claim 51, wherein:
receiving (1130, 1140) the reputation information (230) from a reputation service (310) includes receiving (1130, 1140) an encrypted reputation information (705) from the reputation service (310); and
verifying (1145) that the reputation information (230) is not altered includes decrypting (1145) the encrypted reputation information (705).

53. An article according to claim 51, wherein:
receiving (1130, 1140) the reputation information (230) from a reputation service (310) includes receiving (1130, 1140) a digital signature (715) from the reputation service (310); and
verifying (1145) that the reputation information (230) is not altered includes verifying (1145) that the digital signature (715) corresponds to the reputation information (230).

54. An article according to claim 44, wherein receiving (1130, 1140) the reputation information (230) includes receiving (1140) the reputation information (230) from the reputation service (310) in an unsolicited communication (815) from the reputation service (310).

55. An article according to claim 54, wherein receiving (1140) the reputation information (230) from the reputation service (310) in an unsolicited communication (815) includes informing (1135) the reputation service (310) that the card selector (205) is available to receive reputation information (230) from the reputation service (310).

56. An article according to claim 44, wherein identifying (1010) reputation information (230) applicable to the relying party (130) further includes storing (1110) the reputation information (230) locally to the card selector (205).

57. An article according to claim 43, wherein using (1015) the reputation information (230) includes providing (1205) the reputation information (230) to a user.

58. An article according to claim 57, wherein providing (1205) the reputation information (230) to the user includes providing (1210) the user visual and/or non-visual cues (930, 935) regarding the reputation information (230) applicable to the relying party (130).

59. An article according to claim 57, wherein providing (1205) the reputation information (230) to the user includes providing (1215) metadata (315) about the reputation information (230) to the user.

60. An article according to claim 57, wherein providing (1205) the reputation information (230) to the user includes providing (1205) the reputation information (230) to the user before the user selects the information card (220) to be used in the transaction with the relying party (130).

61. An article according to claim 57, wherein providing (1205) the reputation information (230) to the user includes delaying (1020) transmission of a security token (160) received from an identity provider (135) to the relying party (130) until a release of the security token (160) is confirmed by the user after presentation of the reputation information (230).

62. An article according to claim 43, wherein identifying (1010) reputation information (230) applicable to the relying party (130) includes accessing (105) a reputation information store (225, 320) local to the card selector (205).

63. An article according to claim 43, said storage medium having stored thereon further instructions that, when executed by the machine, result in updating (1110) a local reputation information store (225, 320) containing the reputation information (230) based on the request for the information card (220).
